(19) United States
(12) Patent Application Publication
(10) Pub. No.: US 2026/0016742 A1
(43) Pub. Date: Jan. 15, 2026

(54) AN OPTOMECHANICAL SYSTEM AND AN ELECTRONIC APPARATUS COMPRISING SAID OPTOMECHANICAL SYSTEM

(71) Applicant: Huawei Technologies Co., Ltd., Shenzhen (CN)

(72) Inventors: Lei Jiang, Shanghai (CN); Eero Tuulos, Tampere (FI); Marko Eromaki, Tampere (FI); Wei Tang, Dongguan (CN); Naoki Sekiguchi, Yokohama (JP); Atsushi Yoneyama, Yokohama (JP); Atsushi Horidan, Yokohama (JP)

(21) Appl. No.: 18/995,610

(22) PCT Filed: Nov. 7, 2022
(86) PCT No.: PCT/CN2022/130382

§ 371 Date: Jan. 16, 2025

(51) Int. Cl. G03B 30/00; G03B 5/04; G03B 17/17; H04N 23/55

(52) U.S. Cl. CPC G03B 30/00; G03B 5/04; G03B 17/17; H04N 23/55

(57) ABSTRACT

An optomechanical system for an electronic apparatus, the optomechanical system comprising a first lens arrangement defining a first optical axis and an image sensor intersecting a second optical axis, the second optical axis extending in parallel to the first optical axis. A reflecting element is configured to redirect light between the first lens arrangement and the image sensor, the first lens arrangement and the image sensor being arranged at a first side of the reflecting element. A first actuator is configured to generate at least partial displacement of the first lens arrangement along the first optical axis or displacement of the reflecting element along a displacement axis parallel to the first optical axis.

### CROSS-REFERENCE TO RELATED APPLICATIONS

This application is a national stage of International Application No. PCT/CN2022/130382, filed on Nov. 7, 2022, which is incorporated herein by reference in its entirety.

### TECHNICAL FIELD

The disclosure relates to an optomechanical system for an electronic apparatus, the optomechanical system comprising a lens arrangement, an image sensor, a reflecting element, and an actuator.

### BACKGROUND

There are several difficulties relating to optical systems for portable electronic apparatuses. Portable electronic apparatuses such as smartphones preferably have as small outer dimensions as possible, while optical systems usually require certain minimum dimensions in order to provide sufficiently good image sharpness, spatial frequency, sensitivity etc.

One problem relates to how to provide an imaging system having a very long focal length, such as film equivalent focal lengths equivalent to a range of conventional 90 to 280 mm lens systems.

A narrow field-of-view lens is usually necessary to provide a long focal length. However, a narrow field of view can result in undesirable optical properties. Firstly, the lens modulation transfer function (MTF) values, a measure of sharpness vs spatial frequency, will be limited due to diffraction from the narrow aperture. The lower the values on the MTF curve, the more blurred the image will be and fewer high-frequency details will be visible in the image. Secondly, the sensitivity of the optical system at low light will be insufficient, leading to longer exposure times, in turn resulting in poorer image quality since it's not possible to capture moving objects well using long exposure times, the long exposure time allowing any shaking of hands to deteriorate image quality.

These issues may be avoided, or improved, by providing the imaging system with a larger entrance pupil aperture for this narrow field of view, reducing the diffraction and improving the sensitivity at low light. A larger entrance pupil aperture improves the performance of the optical system, however, it also results in a shorter focal length.

In order to achieve a long focal length with sufficient image quality, prior art solutions suggest folding the light ray path. One such solution is the Cassegrain double reflection-based system. One Cassegrain embodiment comprises a parabolic primary mirror and a hyperbolic secondary mirror that reflects the light through a hole in the primary mirror. By folding the light ray path, the optical system can be designed more compact.

However, the secondary mirror obscures a central portion of the entrance pupil aperture of the system, leaving only a ring-shaped entrance pupil aperture which has a significantly reduced performance compared to a design comprising a fully open entrance aperture. The larger the secondary mirror, the lower the MTF value becomes at lower spatial frequencies.

Hence, there is a need for an improved optomechanical for use in portable and/or smaller electronic apparatuses.

### SUMMARY

It is an object to provide an improved optomechanical system. The foregoing and other objects are achieved by the features of the independent claims. Further implementation forms are apparent from the dependent claims, the description, and the figures.

According to a first aspect, there is provided an optomechanical system for an electronic apparatus, the optomechanical system comprising a first lens arrangement defining a first optical axis; an image sensor intersecting a second optical axis, the second optical axis extending in parallel with the first optical axis; a reflecting element configured to redirect light between the first lens arrangement and the image sensor, the first lens arrangement and the image sensor being arranged at a first side of the reflecting element; and a first actuator configured to generate at least partial displacement of the first lens arrangement along the first optical axis or displacement of the reflecting element along a displacement axis parallel with the first optical axis.

Such a system, reflecting incoming light rays, facilitates a focal length that is longer than the actual outer dimensions of the optomechanical system as well as the reflecting element. A reflecting element providing a longer focal length, when used in an optomechanical system such as that of a camera, results in higher magnification and a narrower field of view. Furthermore, the components facilitating the longer focal length have a small form factor and take up as little space as possible within the electronic apparatus comprising it.

In a possible implementation form of the first aspect, the reflecting element is configured to reflect light, the light entering an interior of the reflecting element via the first lens arrangement, the light being reflected sequentially within the interior of the reflecting element by means of several reflective surfaces, and the light exiting the reflecting element in a direction towards the image sensor. facilitating a long focal length as well as a thin form factor.

In a further possible implementation form of the first aspect, the first actuator is arranged coplanarly with at least one of the first lens arrangement, the reflecting element, and the image sensor within a first plane, ensuring an as thin form factor as possible.

In a further possible implementation form of the first aspect, the first actuator is arranged at a second side of the reflecting element, the second side being opposite the first side of the reflecting element, and wherein the first actuator is configured to generate movement of the reflecting element along the displacement axis, reducing the size of the actuator stroke needed for macro focusing.

In a further possible implementation form of the first aspect, the optomechanical system further comprises a printed circuit board arranged adjacent the second side of the reflecting element, the printed circuit board comprising the first actuator, allowing the actuator to be built into the printed circuit board.

In a further possible implementation form of the first aspect, the first actuator comprises a voice coil motor, a stepper motor, a piezoelectric motor, or a shape memory alloy, allowing any suitable type of simple, small, and reliable type of actuator with low power consumption to be used.

In a further possible implementation form of the first aspect, the optomechanical system further comprises a tunable lens arranged between the first lens arrangement and the reflecting element, the first actuator being arranged coplanarly with the reflecting element and being configured to actuate the tunable lens at least partially along the first optical axis, the tunable lens being configured to engage the first lens arrangement such that actuation of the tunable lens generates movement of at least one lens within the first lens arrangement along the first optical axis. facilitating the integration of autofocus into the optomechanical system.

In a further possible implementation form of the first aspect, the optomechanical system further comprises a second lens arrangement, the second lens arrangement defining the second optical axis and being arranged between the reflecting element and the image sensor, facilitating an even more improved imaging system.

In a further possible implementation form of the first aspect, the optomechanical system
further comprises a second actuator arranged adjacent at least one of the first lens arrangement and the image sensor, and wherein the second actuator is configured to generate movement of the first lens arrangement and/or movement of the image sensor in directions perpendicular to the first optical axis and the second optical axis. This allows optical image stabilization to be achieved separately while still maintaining an as thin form factor as possible.

In a further possible implementation form of the first aspect, the second actuator is configured to generate movement of the first lens arrangement and the second lens arrangement in directions perpendicular to the first optical axis and the second optical axis, allowing autofocus as well as optical image stabilization to be achieved while still maintaining an as thin form factor as possible.

In a further possible implementation form of the first aspect, the second actuator is configured to generate simultaneous movement of the first lens arrangement and the image sensor in directions perpendicular to the first optical axis and the second optical axis, allowing optical image stabilization to be achieved while still maintaining an as thin form factor as possible.

In a further possible implementation form of the first aspect, the second actuator is configured to generate movement of at least one of the first lens arrangement, the second lens arrangement, and the image sensor in directions parallel with the first optical axis and the second optical axis, allowing focus to be achieved using the second actuator.

In a further possible implementation form of the first aspect, the second actuator is configured to generate movement of the first lens arrangement in directions perpendicular to the first optical axis and the second optical axis, and the optomechanical system further comprises a third actuator configured to generate movement of the image sensor in directions perpendicular to the first optical axis and the second optical axis. This allows autofocus and optical image stabilization to be achieved separately while still maintaining an as thin form factor as possible.

In a further possible implementation form of the first aspect, the first actuator, the second actuator, and/or the third actuator comprises a voice coil motor or shape memory alloy, allowing any suitable type of simple, small, and reliable type of actuator with low power consumption to be used.

According to a second aspect, there is provided an electronic apparatus comprising the optomechanical system according to the above. Such a system, reflecting incoming light rays, facilitates a focal length that is longer than the actual outer dimensions of the optomechanical system as well as the reflecting element. A reflecting element providing a longer focal length, when used in an optomechanical system such as that of a camera, results in higher magnification and a narrower field of view. An electronic apparatus comprising such an optomechanical system can have a thin form factor while still having a long focal length.

In a possible implementation form of the second aspect, the optomechanical system is arranged such that the first optical axis and the second optical axis of the optomechanical system extend perpendicular to a main surface of the electronic apparatus, allowing an as compact and accurate optomechanical system as possible, resulting in an electronic apparatus capable of generating high-quality images while still being comparatively small.

These and other aspects will be apparent from the embodiments described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 shows an illustration of an optomechanical system in accordance with an example of the embodiments of the disclosure;

FIG. 2 shows an illustration of an optomechanical system in accordance with an example of the embodiments of the disclosure;

FIG. 3 shows an illustration of an optomechanical system in accordance with an example of the embodiments of the disclosure.

### DETAILED DESCRIPTION OF ILLUSTRATIVE EMBODIMENTS

The present invention relates to an optomechanical system 1 for an electronic apparatus 11, the optomechanical system 1 comprising a first lens arrangement 2 defining a first optical axis A1; an image sensor 3 intersecting a second optical axis A2, the second optical axis A2 extending in parallel with the first optical axis A1; a reflecting element 4 configured to redirect light between the first lens arrangement 2 and the image sensor 3, the first lens arrangement 2 and the image sensor 3 being arranged at a first side of the reflecting element 4; and a first actuator 5 configured to generate at least partial displacement of the first lens arrangement 2 along the first optical axis A1 or displacement of the reflecting element 4 along a displacement axis A3 parallel with the first optical axis A1.

The present invention also relates to an electronic apparatus 11 comprising the optomechanical system 1 described in more detail below. The electronic apparatus 11 may be a smartphone, a tablet, a wearable, or any type of electronic device provided with an optical system.

The optomechanical system 1 may be arranged such that the first optical axis A1, defined by the first lens arrangement 2, as well as an optional second optical axis A2, defined by a second lens arrangement 9, of the optomechanical system 1 extend perpendicular to a main surface of the electronic apparatus. The main surface of the electronic apparatus may for example be formed by the wall of a housing, the housing wall comprising a light ray path entrance aperture arranged coaxially with the first lens arrangement 2. The entrance aperture may be circular and have an unobstructed inner diameter allowing all light entering the aperture to travel without obstructions through the first lens arrangement 2 and to the reflecting element 4.

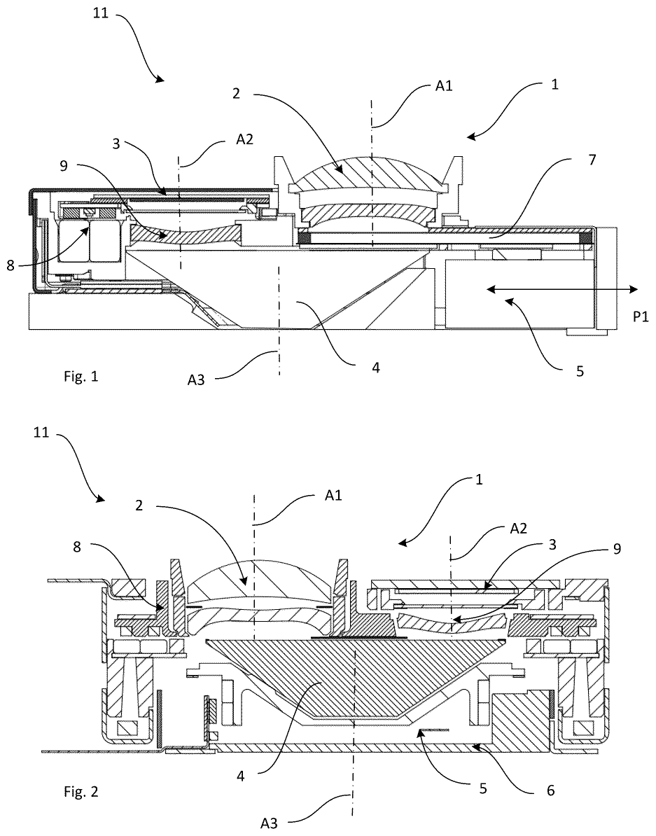

The optomechanical system 1 comprises, as mentioned, a first lens arrangement 2 defining a first optical axis A1, as illustrated in FIGS. 1 to 3.

An image sensor 3 is arranged such that it intersects a second optical axis A2, the second optical axis A2 extending in parallel with the first optical axis A1.

The optomechanical system 1 may also comprise a second lens arrangement 9, the second lens arrangement 9 defining the second optical axis A2 and being arranged between the reflecting element 4 and the image sensor 3.

The second lens arrangement 9 may be arranged such that its optical axis is coaxial with the optical axis A2 of the image sensor 3. The first lens arrangement 2 and the second lens arrangement 9 may be arranged such that the optical axis of the second lens arrangement 9 is parallel with the optical axis A1 of the first lens arrangement 2.

The first lens arrangement 2 and the second lens arrangement 9 may each comprise at least one lens. A diffractive optical element may be included at the front of the first lens arrangement 2, to reduce the total number of lenses while still maintaining sufficient color correction. Furthermore, the first lens arrangement 2 may comprise a prism, e.g. a freeform prism, in order to improve and simplify the first lens arrangement 2.

The lenses of the second lens arrangement 9 may have any suitable cut such as I-cut or D-cut, which frees up space within the second lens arrangement 9.

A reflecting element 4 is configured to redirect light between the first lens arrangement 2 and the image sensor 3, the first lens arrangement 2 and the image sensor 3 being arranged at a first side of the reflecting element 4. The first side of the reflecting element 4 may be a side configured to face the exterior when arranged within an electronic apparatus.

The reflecting element 4 may be configured to reflect light within its interior. The light enters the interior of the reflecting element 4 via the first lens arrangement 2, the light is thereafter reflected sequentially within the interior of the reflecting element 4 by means of several reflective surfaces, and the light finally exits the reflecting element 4 in a direction towards the image sensor 3. The reflecting element 4 comprises at least three reflective surfaces, and the reflective surfaces may comprise mirrors. At least one surface of the reflecting element 4 may be configured to reflect light rays by means of total internal reflection.

The first lens arrangement 2 may be arranged adjacent a first area of a main surface of the reflecting element 4, while the image sensor 3 may arranged adjacent a second area of a main surface of the reflecting element 4. The optical axes of the first lens arrangement 2 and the image sensor 3 may extend perpendicular to the main surface of the reflecting element 4.

The optomechanical system 1 may be configured such that a light ray path travels through the first lens arrangement 2 and into the interior of the reflecting element 4. The light ray path is thereafter reflected within the interior by means of several reflective surfaces, finally, the light ray path exits the reflecting element 4 whereafter it reaches the image sensor 3.

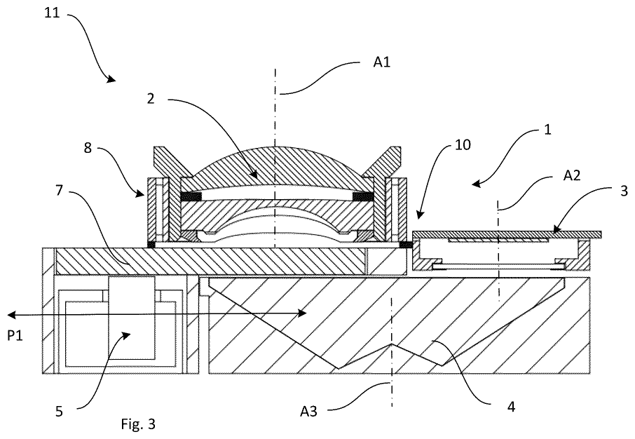

A first actuator 5 is configured to generate at least partial displacement of the first lens arrangement 2 along the first optical axis A1, as illustrated in FIGS. 1 and 3, or to generate displacement of the reflecting element 4 along a displacement axis A3 parallel with the first optical axis A1, as illustrated in FIG. 2.

The first actuator 5 may be arranged coplanarly with at least one of the first lens arrangement 2, the reflecting element 4, and the image sensor 3 within a first plane P1. As illustrated in FIGS. 1 and 3, the first actuator 5 may be arranged coplanarly with reflecting element 4. The first actuator 5 may be arranged to the side of the reflecting element 4, or it may be arranged to enclose the reflecting element 4 and optionally other components of the optomechanical system 1.

As illustrated in FIG. 2, the first actuator 5 may be arranged at a second side of the reflecting element 4, the second side being opposite the first side of the reflecting element 4. In other words, the second side of the reflecting element 4 may be a side configured to face the interior of the electronic apparatus 11.

The first actuator 5 may be configured to generate movement of the reflecting element 4 along the displacement axis A3. In such an embodiment, the first lens arrangement 2 may be fixed.

The optomechanical system 1 may comprise a printed circuit board 6 arranged adjacent the second side of the reflecting element 4. The printed circuit board 6 may comprise the first actuator 5, such that the first actuator 5 is part of the printed circuit board 6.

The first actuator 5 may comprise a voice coil motor, a stepper motor, a piezoelectric motor, or a shape memory alloy.

As illustrated in FIGS. 1 and 3, the optomechanical system 1 may further comprise a tunable lens 7 arranged between the first lens arrangement 2 and the reflecting element 4. The first actuator 5 may be arranged coplanarly with the reflecting element 4 and configured to actuate the tunable lens 7 at least partially along the first optical axis A1. The tunable lens 7 is, in other words, configured to engage the first lens arrangement 2 such that actuation of the tunable lens 7 generates movement of at least one lens within the first lens arrangement 2 along the first optical axis A1. The tunable lens 7 may comprise an optical liquid or a soft optical material, and it may move the first lens arrangement 2, or a lens of the first lens arrangement 2, by pushing it.

The tunable lens 7 may be used in order to integrate the autofocus function. However, autofocus may also be executed, e.g., by moving the reflecting element 4 along the displacement axis A3.

The optomechanical system 1 may further comprise a second actuator 8 arranged adjacent at least one of the first lens arrangement 2 and the image sensor 3. The second actuator 8 is configured to generate movement of the first lens arrangement 2, as shown in FIGS. 2 and 3, and/or movement of the image sensor 3, as shown in FIG. 1, in directions perpendicular to the first optical axis A1 and the second optical axis A2.

Optical image stabilization (OIS) may be executed, e.g., by moving the first lens arrangement 2, and optionally the second lens arrangement 9, in a xy-plane, its optical axis A1 being the z-axis; or by moving the image sensor 3 in a xy-plane.

The second actuator 8 may be configured to generate movement of the first lens arrangement 2 and the second lens arrangement 9 in directions perpendicular to the first optical axis A1 and the second optical axis A2, as illustrated in FIG. 2.

The second actuator 8 may be configured to generate simultaneous movement of the first lens arrangement 2 and the image sensor 3 in directions perpendicular to the first optical axis A1 and the second optical axis A2. The same second actuator 8 may, in other words, be used for moving the first lens arrangement 2 as well as the image sensor 3.

The second actuator 8 may also be configured to generate movement of at least one of the first lens arrangement 2, the second lens arrangement 9, and the image sensor 3 in directions parallel with the first optical axis A1 and the second optical axis A2, such that the second actuator 8 can achieve focusing.

The second actuator 8 may be configured to generate movement of only the first lens arrangement 2 in directions perpendicular to the first optical axis A1 and the second optical axis A2. The optomechanical system 1 may, in such an embodiment, comprise a third actuator 10 as illustrated in FIG. 3. The third actuator 10 may be configured to generate so-called sensor shift, i.e., movement of the image sensor 3 in directions perpendicular to the first optical axis A1 and the second optical axis A2. The second actuator 8 may, in other words, be used for moving the first lens arrangement 2 while the third actuator 10 is used for moving the image sensor 3.

The first actuator 5, the second actuator 8, and/or the third actuator 10 may comprise a voice coil motor or a shape memory alloy.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

1.-16. (canceled)

17. An optomechanical system, the optomechanical system comprising:
a first lens arrangement defining a first optical axis;
an image sensor intersecting a second optical axis, the second optical axis extending in parallel to the first optical axis;
a reflecting element configured to redirect light between the first lens arrangement and the image sensor, the first lens arrangement and the image sensor being arranged at a first side of the reflecting element; and
a first actuator configured to generate at least partial displacement of the first lens arrangement along the first optical axis or displacement of the reflecting element along a displacement axis parallel to the first optical axis.

18. The optomechanical system according to claim 17, wherein the light entering an interior of the reflecting element via the first lens arrangement, the light being reflected sequentially within the interior of the reflecting element by several reflective surfaces, and the light exiting the reflecting element in a direction towards the image sensor.

19. The optomechanical system according to claim 17, wherein the first actuator is arranged coplanarly with at least one of the first lens arrangement, the reflecting element, or the image sensor within a first plane.

20. The optomechanical system according to claim 17, wherein the first actuator is arranged at a second side of the reflecting element, the second side being opposite the first side of the reflecting element, and wherein the first actuator is configured to generate movement of the reflecting element along the displacement axis.

21. The optomechanical system according to claim 20, further comprising a printed circuit board arranged adjacent to the second side of the reflecting element, the printed circuit board comprising the first actuator.

22. The optomechanical system according to claim 20, wherein the first actuator comprises a voice coil motor, a stepper motor, a piezoelectric motor, or a shape memory alloy.

23. The optomechanical system according to claim 20, further comprising a tunable lens arranged between the first lens arrangement and the reflecting element, the first actuator being arranged coplanarly with the reflecting element and being configured to actuate the tunable lens at least partially along the first optical axis, the tunable lens being configured to engage the first lens arrangement such that actuation of the tunable lens generates movement of at least one lens within the first lens arrangement along the first optical axis.

24. The optomechanical system according to claim 17, further comprising a second lens arrangement, the second lens arrangement defining the second optical axis and being arranged between the reflecting element and the image sensor.

25. The optomechanical system according to claim 24, further comprising a second actuator arranged adjacent to at least one of the first lens arrangement or the image sensor, and wherein the second actuator is configured to generate at least one of movement of the first lens arrangement or movement of the image sensor in directions perpendicular to the first optical axis and the second optical axis.

26. The optomechanical system according to claim 25, wherein the second actuator is configured to generate movement of the first lens arrangement and the second lens arrangement in directions perpendicular to the first optical axis and the second optical axis.

27. The optomechanical system according to claim 25, wherein the second actuator is configured to generate simultaneous movement of the first lens arrangement and the image sensor in directions perpendicular to the first optical axis and the second optical axis.

28. The optomechanical system according to claim 25, wherein the second actuator is configured to generate movement of at least one of the first lens arrangement, the second lens arrangement, or the image sensor in directions parallel to the first optical axis and the second optical axis.

29. The optomechanical system according to claim 25, wherein the second actuator is configured to generate movement of the first lens arrangement in directions perpendicular to the first optical axis and the second optical axis, and wherein the optomechanical system further comprises a third actuator configured to generate movement of the image sensor in directions perpendicular to the first optical axis and the second optical axis.

30. The optomechanical system according to claim 29, wherein at least one of the first actuator, the second actuator, or the third actuator comprises a voice coil motor or shape memory alloy.

31. An electronic apparatus comprising an optomechanical system, wherein the optomechanical system comprising
a first lens arrangement defining a first optical axis;
an image sensor intersecting a second optical axis, the second optical axis extending in parallel to the first optical axis;
a reflecting element configured to redirect light between the first lens arrangement and the image sensor, the first lens arrangement and the image sensor being arranged at a first side of the reflecting element; and
a first actuator configured to generate at least partial displacement of the first lens arrangement along the first optical axis or displacement of the reflecting element along a displacement axis parallel to the first optical axis.

32. The electronic apparatus according to claim 31, wherein the light entering an interior of the reflecting element via the first lens arrangement, the light being reflected sequentially within the interior of the reflecting element by several reflective surfaces, and the light exiting the reflecting element in a direction towards the image sensor.

33. The electronic apparatus according to claim 31, wherein the first actuator is arranged coplanarly with at least one of the first lens arrangement, the reflecting element, or the image sensor within a first plane.

34. The electronic apparatus according to claim 31, wherein the first actuator is arranged at a second side of the reflecting element, the second side being opposite the first side of the reflecting element, and wherein the first actuator is configured to generate movement of the reflecting element along the displacement axis.

35. The electronic apparatus according to claim 34, further comprising a printed circuit board arranged adjacent to the second side of the reflecting element, the printed circuit board comprising the first actuator.

36. The electronic apparatus according to claim 34, wherein the first actuator comprises a voice coil motor, a stepper motor, a piezoelectric motor, or a shape memory alloy.
